(19) United States
(12) Patent Application Publication
(10) Pub. No.: US 2011/0279286 A1
(43) Pub. Date: Nov. 17, 2011

(54) ENERGY-RELATED INFORMATION DISPLAY APPARATUS AND METHOD THEREOF

(75) Inventors: Dong Min SON, Suwon (KR); Jae Seong PARK, Daejeon (KR); Jung Hwan OH, Seoul (KR)

(73) Assignee: LSIS CO., LTD.

(21) Appl. No.: 13/098,318

(22) Filed: Apr. 29, 2011

(30) Foreign Application Priority Data
May 11, 2010 (KR) 10-2010-0044069

(51) Int. Cl. G08C 15/06

(52) U.S. Cl. 340/870.02

(57) ABSTRACT

Disclosed is an energy-related information display apparatus included in each energy consumption place, which displays energy price information that a central server transmits according to a time zone, harmonizing with a floating energy rate system. When not receiving energy price information from a central server, a predicted energy price is provided. The prediction of the energy price can be reasonably performed on the basis of energy price information that was received from the central server in the past. The predicted energy price is transmitted to a user's mobile terminal as well as displayed on a display module so that the user can immediately identify it. Accordingly, the present disclosure can help user make a decision related with energy usage and properly meet a situation that energy price is not normally proved.

Pursuant to 35 U.S.C. §119 (a), this application claims the benefit of earlier filing date and right of priority to Korean Patent Application No. 10-2010-0044069, filed on May 11, 2010, the contents of which are hereby incorporated by reference in their entirety.

### BACKGROUND OF THE DISCLOSURE

1. Field of the Invention

The present disclosure relates to an energy-related information display apparatus and a method thereof. And more particularly, the present disclosure can suitably take action against a case where energy price information is not normally received due to a communication problem under a floating rate system in which the price of various energy such as electricity, gas and water supply continuously changes depending on time zone.

2. Description of the Related Art

Until now, various kinds of energies such as electricity, gas and water supply have been provided according to the maximum demand and energy price also has been kept steady.

However, a way to grade energy price by sectionalizing it depending on time zone or seasonal zone is recently being considered as a measure to use energy resources more efficiently and to reduce energy consumption.

One of examples related with such a way is a Smart Grid, which is a next generation power network in which a power network is integrated with an information technology to exchange real-time information between a power supplier and a consumer in two-way so that energy efficiency is optimized and a new added value is created.

On the view point of an energy consumer, the smart grid enables the energy consumer to find the most reasonable time zone in a fluctuating energy price depending on the time zone and use energy.

In addition to the smart grid, a Smart Meter is a digital integrated energy meter having a communication function, which can perform a real-time search of integrated power energy used or a two-way communication between a power supplier and a power consumer.

Therefore, it is possible to read meter remotely without visiting home by a meterman and to precisely measure an amount of power consumption due to the real-time reading, so that there is an advantageous effect in that reading expense and energy can be saved.

Further, since it is possible to provide consumer energy usage information through a communication network such as Internet, the consumer can identify his or her energy usage information using various communication units such as Web, mobile phone and TV set at any time and place.

When a floating rate system in which energy price changes depending on time zone is implemented with the development of energy related technologies such as smart grid and smart meter, each consumer is able to confirm the energy price fluctuating frequently.

However, it may be possible that energy price information is not smoothly provided due to a communication network problem or a system problem of energy provider. In this case, there is needed a way to inform consumer that the price information is not received so as that the consumer can suitably take action against that.

### SUMMARY OF THE INVENTION

The present disclosure displays energy price information that frequently fluctuates depending on time zone under a floating rate system and suggests an estimated price that is predicted when not receiving the energy price information smoothly, whereby a user suitably meets a problem.

A first embodiment of an energy-related information display apparatus according to the present disclosure receives and displays energy usage information and energy price information.

The energy-related information display apparatus of the first embodiment includes a meter for detecting energy; a usage information display unit for receiving the energy usage information from the meter and displaying the energy usage information; a sensor for sensing a communication state between a central server and the energy-related information display apparatus; a received information display unit for displaying energy price information when receiving the energy price information from the central server; and an estimated information display unit for displaying a message indicating that energy price information is not received and energy estimated price information, when not receiving the energy price information from the central server.

A second embodiment of an energy-related information display apparatus according to the present disclosure receives and displays energy price information.

The energy-related information display apparatus of the second embodiment includes a sensor for sensing a communication state between a central server and the energy-related information display apparatus; a received information display unit for displaying energy price information when receiving the energy price information from the central server; and an estimated information display unit for displaying a message indicating that energy price information is not received and energy estimated price information, when not receiving the energy price information from the central server.

A third embodiment of an energy-related information display apparatus according to the present disclosure receives and displays energy price information.

The energy-related information display apparatus of the third embodiment

includes a sensor for sensing a communication state between a central server and the energy-related information display apparatus; a received information display unit for displaying energy price information when receiving the energy price information from the central server; an estimation unit for predicting a future energy price on the basis of past energy price information received from the central server; and a transmission unit for transmitting a message indicating that energy price information is not received and energy price information that the estimation unit has predicted, when not receiving the energy price information from the central server.

The first to third embodiments of the energy-related information display apparatus may further include energy source switching unit that switches an energy supply source with an alternative energy source or an auxiliary battery by controlling an energy source switch when the communication state with the central server is not normal.

A first embodiment of an energy-related information display method according to the present disclosure includes detecting energy with a meter; receiving energy usage information from the meter and displaying the energy usage information; sensing a communication state between a central server and the energy-related information display apparatus; displaying energy price information when receiving the energy price information from the central server; and displaying a message indicating that energy price information is not received and energy estimated price information, when not receiving the energy price information from the central server.

A second embodiment of an energy-related information display method according to the present disclosure includes sensing a communication state between a central server and the energy-related information display apparatus; displaying energy price information when receiving the energy price information from the central server; and displaying a message indicating that energy price information is not received and energy estimated price information, when not receiving the energy price information from the central server.

A third embodiment of an energy-related information display method

according to the present disclosure includes sensing a communication state between a central server and the energy-related information display apparatus; displaying energy price information when receiving the energy price information from the central server; and transmitting energy estimated price information predicted on the basis of the energy price information that has been received in the past together with a message indicating the energy price information is not received, when not receiving the energy price information from the central server.

Preferably the energy is anyone of electricity, gas and water supply.

An error message or a blank message may be displayed instead of the energy price information when not receiving the energy price information from the central server.

Further, at least one of the maximum value and the minimum value in the energy price together with the energy price information may be displayed.

Estimation or prediction of the energy price may be performed on the basis of the energy price information of the previous day or the previous month when not receiving the energy price information from the central server.

The energy price to be displayed or transmitted may be the latest receive energy price when not receiving the energy price information from the central server.

The message indicating that energy price information is not received and price information to be estimated or predicted may be transmitted to a user's mobile terminal or an IHD (In Home Display).

The energy-related information display apparatus according to the present disclosure receives energy price information that basically fluctuates depending on time zone from a central server and displays the information. If there occurs a situation that the energy price information is not received smoothly, a message to inform a user of this and an energy estimated price are suggested.

Since the energy price does not suddenly change even in a floating rate system, it is possible to predict an energy estimated price on the basis of the energy price that was previously received from a central server, so that a reasonable result can be derived.

When transmitting information such as a communication state with a central server and an energy estimated price to a variety of devices having an excellent accessibility to a user such as a mobile terminal and an IHD (In Home Display), the user can recognize the situation easily.

As such, in a case that an energy price reception is not performed smoothly under a floating rate system, when a message indicating the above and an energy estimated price are suggested to a user, it can be helpful for the user to make a decision related with energy usage and to suitably meet such a situation.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description, serve to explain the principle of the disclosure. In the drawings:

FIG. 1 is an example illustrating an energy-related information display apparatus that is connected to a central server through a communication network;

FIG. 2 is an example illustrating a construction of a central server;

FIG. 3 is a block diagram illustrating a first embodiment of an energy-related information display apparatus according to the present disclosure;

FIG. 4 is an example illustrating a display screen that displays energy prices;

FIG. 5 is a block diagram illustrating a second embodiment of an energy-related information display apparatus according to the present disclosure;

FIG. 6 is a block diagram illustrating a third embodiment of an energy-related information display apparatus according to the present disclosure;

FIG. 7 is an embodiment to switch an energy source according to a communication state;

FIG. 8 is a detailed example of a construction of an energy-related information display apparatus;

FIG. 9 is a flow chart illustrating a first embodiment of an energy-related information display method according to the present disclosure;

FIG. 10 is a flow chart illustrating a second embodiment of an energy-related information display method according to the present disclosure;

FIG. 11 is a flow chart illustrating a third embodiment of an energy-related information display method according to the present disclosure.

### DETAILED DESCRIPTION OF THE PREFERRED EMBODIMENTS

Hereinafter, a detailed description is an embodiment of the present disclosure only and nothing but an illustration. Further, principle and concept of the present disclosure are provided for the purpose of describing the present disclosure with ease.

Unless mentioned otherwise, the term “energy” used herein refers to anyone of electricity, gas and water supply.

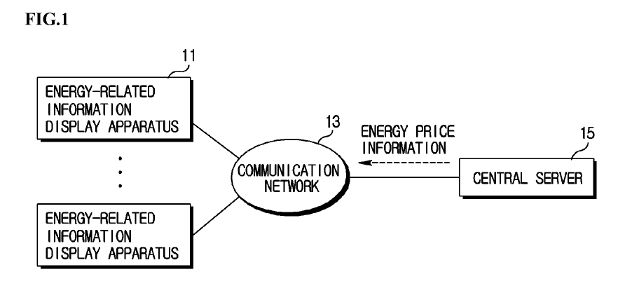

Referring to FIG. 1, an energy-related information display apparatus 11 is located in an energy consumption place such as home, office and company, which receives energy price information that frequently fluctuates depending on time zone from a central server 15 thorough a communication network 13 and displays the information thereon.

The central server 15 is a server with which an energy provider or a business qualified to provide each user with energy price information provides the energy price information that fluctuates depending on time zone through a communication network 13.

The central server 15 is constructed using a computer device that can provide the energy price information through the communication network 13, whose structure, performance and format can be variously changed.

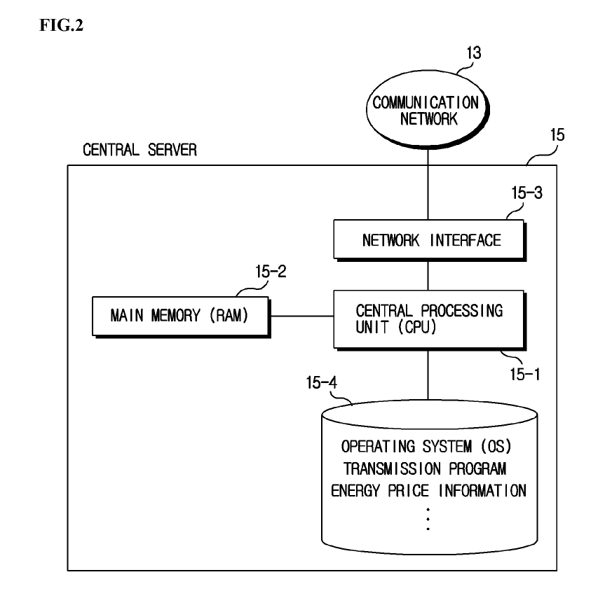

Referring to FIG. 2, the central server 15 is constructed of a central processing unit 15-1, a RAM 15-2 used as a main memory device, a network interface 15-3 enabling the central server to access and communicate with the communication network 13 and a storage medium 15-4.

The storage medium 15-4 has a non-volatile property to read and write digital data. While built-in hard disc drive is generally used as the storage medium 15-4, the storage medium may have various types such as built-in type, external type, detachable type and non-detachable type.

The storage medium 15-4 stores an operation system OS, various kinds of computer programs and data. Especially, the storage medium 15-4 has energy price information that fluctuates depending on time zone and a transmission program that transmits the energy price information through the communication network on a transmission time.

The transmission program stored in the storage medium 15-4 is stored in the main memory device 15-2 by the central processing unit 15-1.

The central processing device 15-1 transmit the energy price information to the communication network 13 through the network interface 15-3 on a transmission time by executing the transmission program stored in the main memory device 15-2.

Energy price transmitted by the central server 15 can be set according to various standards such as time, day of the week and season.

While the time when the energy price information is transmitted can be variously set according to the need, the energy price information can be periodically transmitted, for example.

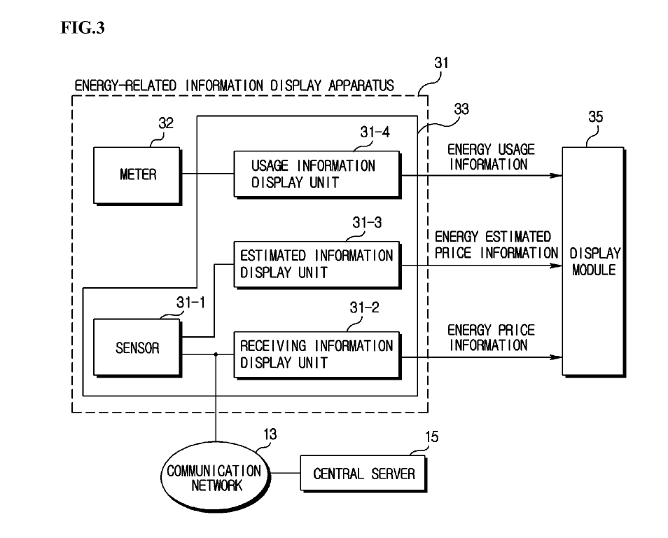

Describing a fist embodiment of an energy-related information display apparatus according to the present disclosure with reference to FIG. 3, the energy-related information display apparatus 31 includes a sensing unit 31-1, a receiving information display unit 31-2, an estimated information display unit 31-3, and a meter 32.

A usage information display unit 31-4, the sensing unit 31-1, the receiving information display unit 31-2 and the estimated information display unit 31-3 can be constructed as an apparatus 33 separated from the meter 32.

The meter 32 serves as a gauge to detect energy and grasp energy usage information.

The energy usage information detected by the meter 32 becomes a basic material to bill a user for used energy, and a material with which an energy provider determines energy price and establishes energy provision plan.

Structure and type of the meter 32 can be variously constructed according to many factors such as function, design and kind of energy, and the meter 32 exchanges energy usage information with the usage information display unit 31-4 of the energy-related information display apparatus.

The meter 32 and the usage information display unit 31-4 exchange the energy usage information with each other using various wired or wireless local are network scheme.

The usage information display unit 31-4 receives the energy usage information from the meter 32 and displays the information on a display module 35.

The receiving information display unit 31-2 receives energy price information transmitted by the central server 15 through the communication network 13 and displays the information on the display module 35.

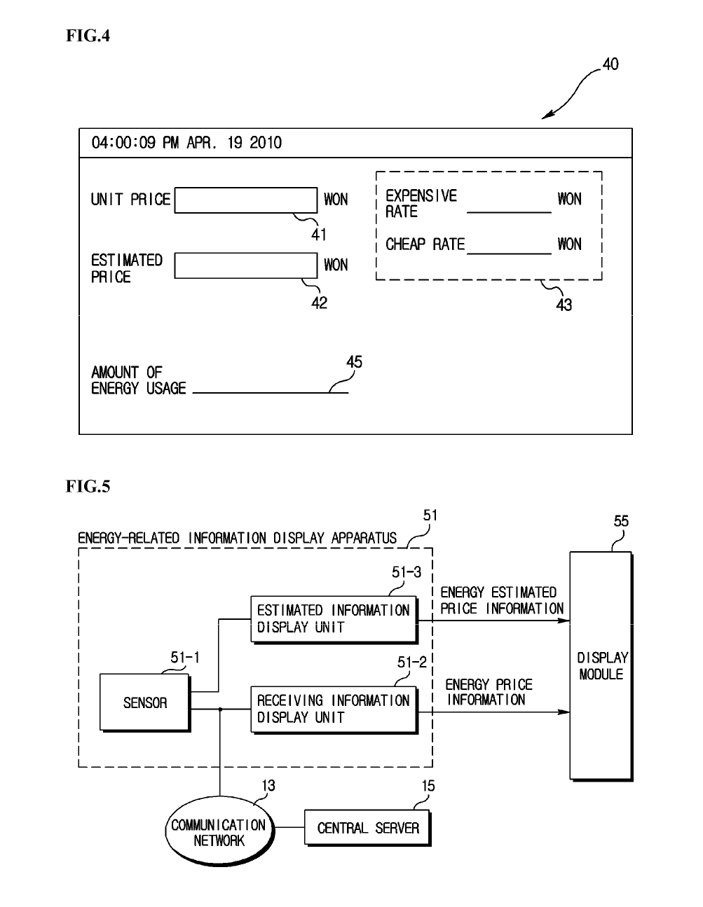

FIG. 4 shows an example of a display screen 40 on which energy price information is displayed, including an item 45 indicating energy usage information displayed by the usage information display unit 31-4 and an item 41 indicating an energy price displayed by the receiving information display unit 31-2, the energy price being received by the receiving information display unit 31-2 through the central server 15.

The amount of energy usage can be variously displayed, including the total amount of usage, the amount of a certain period, the total charge of usage, and the charge of usage of a certain period.

FIG. 4 is a view suggested to make the description understood easily, and can be variously constructed to provide the user with many kinds of energy-related information.

The sensing unit 31-1 senses a communication state between the central server 15 and the energy-related information display apparatus 31 and monitors whether the energy price information is normally received from the central server 15.

The method how the sensing unit 31-1 monitors a communication state communicating with the central server 15 can be variously constructed.

For example, when the central server 15 and the energy-related information display apparatus 31 periodically exchange the energy price information with each other, it is possible to confirm whether the energy price information is received from the central server 15 at the period.

If the communication state between the central server 15 and the energy-related information display apparatus 31 is not normal and so the energy price information is not received, the sensing unit 31-1 informs the estimation information display unit 31-3 of it.

When the energy price information is not normally received from the central server 15 as a sensing result of the sensing unit 31-1, the estimation information display unit 31-3 displays a message indicating that the energy price information is not received and energy estimated price information on the display module 35.

Referring to FIG. 4, the estimation information display unit 31-3 outputs the energy estimation price to the item 42 that displays the estimation price.

The display module 35 can have various formats such as LCD (Liquid Crystal Display) and LED (Light Emitting Diode).

Further, while the display module 35 is illustrated separately from the energy-related information display apparatus 31 in FIG. 3, the display module 35 can be included in the energy-related information display apparatus 31 or included separately from the energy-related information display apparatus and then they can be linked with each other.

In describing a second embodiment of the energy-related information display apparatus according to the present disclosure with reference to FIG. 3, the energy-related information display apparatus 51 includes a sensing unit 51-1, a receiving information display unit 51-2, and an estimated information display unit 51-3.

The receiving information display unit 51-2 receives energy price information that is transmitted by the central server 15 through the communication network 13, and displays the information on a display module 55.

An example of screen on which the receiving information display unit 51-2 displays the energy price information is the same as FIG. 4.

The sensing unit 51-1 senses a communication state between the central server 15 and the energy-related information display apparatus 51, and then monitors whether the energy price information is normally received from the central server 15.

The method to monitor a communication state between the sensing unit 51-1 and the central server 15 can be variously constructed.

For example, when the central server 15 and the energy-related information display apparatus 51 periodically exchange the energy price information with each other, the sensing unit 51-1 can identify whether the energy price information is received at the period.

When the communication state between the central server 15 and the energy-related information display apparatus 51 is not normal as a result of sensing it, the estimated information display unit 51-3 displays a message indicating that the energy price information is not received and the energy estimated price information on the display module 55.

Referring to FIG. 4, the estimated information display unit 51-3 outputs the energy estimated price to the item 42 that displays an estimated price.

The display module 55 can have various forms such as LCD or LED, and it can be included in the energy-related information display apparatus 51 or included separately from the energy-related information display apparatus 51 and then they can be linked with each other.

In the energy-related information display apparatus 31 and 51 of the first and second embodiments described above, the method that the estimated information display units 31-3 and 51-3 produce the energy estimated price can be constructed variously, and especially current energy price can be estimated on the basis of energy price information that was received from the central server 15 in the past.

As an example, an energy estimation price can be produced on the basis of energy price information of the previous day or the previous month.

That is, an average energy price of the previous day or the previous month, the energy price that was received at the same time zone of the previous day, and the energy price that was received at the same month, the same day and same time zone of the previous year are produced as the energy estimated price.

As another example, the estimation information display units 31-3 and 51-3 can select the latest received energy price information of the energy price information that was received before the communication state with the central server 15 became abnormal as an energy estimated price.

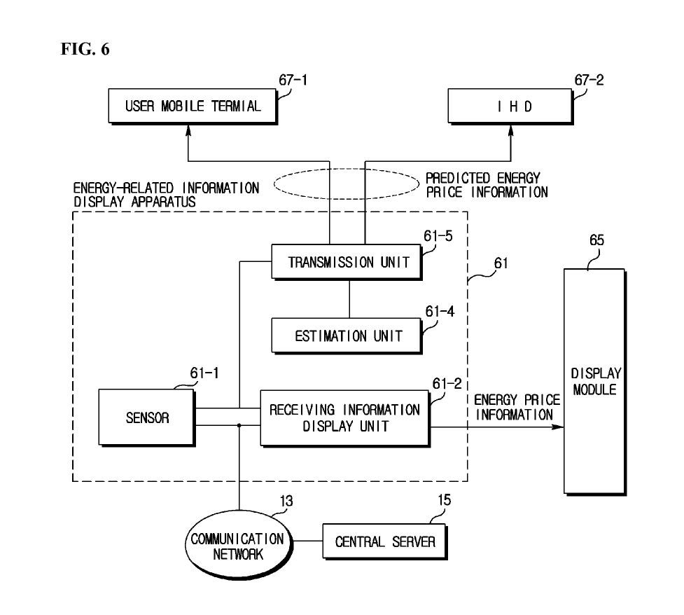

On describing a third embodiment of the energy-related information display apparatus according to the present disclosure with reference to FIG. 6, the energy-related information display apparatus 61 includes a sensing unit 61-1, a receiving information display unit 61-2, an estimation unit 61-4 and a transmission unit 61-5.

The receiving information display unit 61-2 receives energy price information that the central server 15 transmits through the communication network 13, and displays the information on a display module 65.

An example of screen on which the receiving information display unit 61-2 displays the energy price information is the same as FIG. 4.

The sensing unit 61-1 senses a communication state between the central server 15 and the energy-related information display apparatus 51 and monitors whether energy price information is normally received from the central server 15.

A method how the sensing unit 61-1 monitors the communication state between the central server 15 and the energy-related information display apparatus can be variously constructed. For example, when the central server 15 and the energy-related information display apparatus 61 periodically exchange energy price information with each other, the sensing unit 61-1 can identify whether the energy price information is received from the central server 15 at the period.

When the communication state between the central server 15 and the energy-related information display apparatus 61 is not normal as a result of sensing and so the energy price information is not received, the sensing unit 61-1 informs the transmission unit 61-5 of it.

The estimation unit 61-4 predicts a future energy price on the basis of past energy price information that was received from the central server 15.

A method how the estimation unit 61-4 predicts an energy price can be variously constructed, and one example of it is to predict an energy price on the basis of energy price information of the previous day or the previous month.

That is, an average energy price of the previous day or the previous month, an energy price that was received at the same time zone of the previous day, and an energy price that was received at the same month, the same day and same time zone of the previous year are predicted as a current energy price.

As another example that the estimation unit 61-4 predicts an energy price, the estimation unit 61-4 can predict the latest received energy price information of the energy price information that was received before the communication state with the central server 15 became abnormal as a current energy price.

When the energy price information is not received from the central server 15 as a result of sensing, the transmission unit 61-5 transmits a message indicating that energy price information is not received and energy price information predicted by the estimation unit 61-4.

The message indicating that the transmission unit 61-5 does not receive energy price information and where the predicted energy price information is transmitted can be variously constructed.

As an example, the energy price information can be transmitted to various kinds of user mobile terminal such as mobile phone, mobile communication terminal and notebook computer. At this time, the transmission unit 61-5 can transmit the energy price information as short message or multimedia message through a communication network capable of communicating with the user mobile terminal such as wired/wireless Internet network and mobile communication network.

As another example, the transmission unit 61-5 transmits a message indicating that the energy price information is not received and predicted energy price information to an IHD (In Home Display) included in house so that the message and information are output through the IHD.

At this time, the transmission unit 61-5 can communicate with the IHD through various wired/wireless LAN communication schemes.

In the first and third embodiments of the energy-related information display apparatus described above, when the receiving information display units 31-2, 51-2 and 61-2 cannot receive the energy price information from the central server 15, they can display an error message or a blank message instead of the energy price information.

Referring to an example illustrated in FIG. 4, when the receiving information display units 31-2, 51-2 and 61-2 do not receive energy price information from the central server 15 as sensing results of the sensing units 31-1, 51-1 and 61-1, they output an error message such as ‘communication error’ or a blank message in an item 41 that displays an energy price.

The central server 15 can transmit various kinds of additional information as well as current energy price information, and the additional information may include the maximum value information and the minimum value information of an energy price.

In this case, the receiving information display units 31-2, 51-2 and 61-2 of the first to third embodiments of the energy-related information display apparatus can display the maximum value information and the minimum value information of the energy price received from the central server 15 together with energy price information. An item 43 in which the maximum value information and the minimum value information of the energy price are displayed is illustrated in FIG. 4.

Further, the receiving information display units 31-1, 51-1 and 61-1 can select the highest price of energy price information that was received from the central server 15 in the past as the maximum value, and the lowest price as the minimum value, and display them.

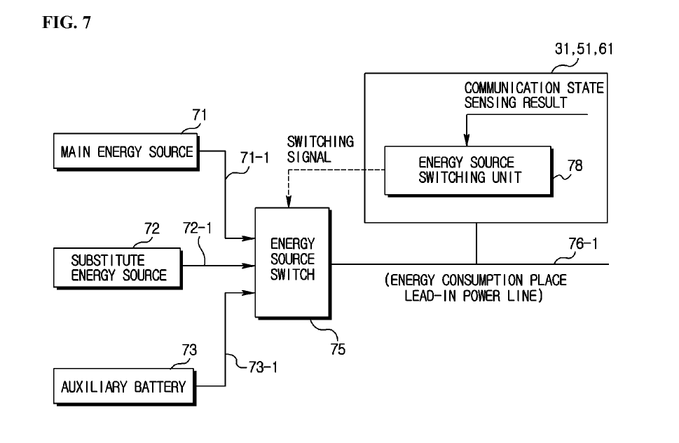

Referring to FIG. 7, the energy-related information display apparatuses 31, 51 and 61 of the first to third embodiments can further include an energy source switching unit 78 that controls an energy source switch 75 and switches an energy source of energy consumption place to a substitute energy source 72 or an auxiliary battery 73 when a communication state with the central server 15 is not normal.

The main energy source 71 refers to a power plant of a power provider, and the substitute energy source 72 refers to power generation equipment that provides the energy consumption place with power using solar cell power generation or wind power generation. The substitute energy source 72 may be individually installed at the energy consumption place.

The energy source switch 75 selectively connects anyone of power lines 71-1, 72-1 and 73-1 of the main energy source 71, a substitute energy source 72 and the auxiliary battery source 73 to a power line 76-1 that leads into an energy consumption place according to a switching signal.

When the sensing units 31-1, 51-1 and 61-1 can not smoothly receive energy price information from the central server 15, they inform the energy source switching unit 78 of a communication state sensing result, and accordingly the energy source switching unit 78 transfers a switching signal to switch to the substitute energy source 72 or the auxiliary battery 73 to the energy source switch 75.

Accordingly, a user who consumes energy uses the substitute energy instead of the energy provided by the main energy source when energy price is in an unclear state.

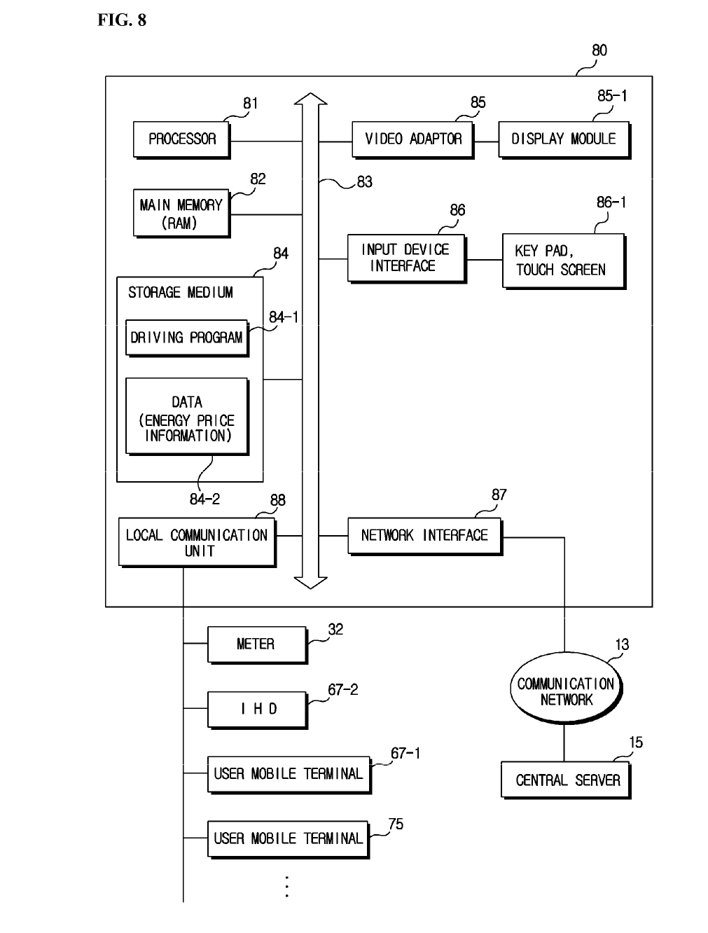

FIG. 8 is a detailed example of a construction of an energy-related information display apparatus 80, and each embodiment of an energy-related information display apparatus according to the present disclosure will be described with reference to the example.

FIG. 8 is not illustrated to separate it from each embodiment of energy-related information display apparatus described above, and can be each embodiment of the energy-related information display apparatus according to contents of a driving program 84-1.

Further, each element of the energy-related information display apparatus 80 can selectively exist according to each embodiment of an energy-related information display apparatus of the present disclosure, even though each element is integrally illustrated.

A local communication unit 88 can be constructed to interface with a wide area communication network such as a mobile communication network as well as a local area near an energy consumption place according to a communication target despite its term.

A processor 81 is constructed using a central processing unit CPU or a microprocessor, which generally controls the energy-related information display apparatus 80 while it exchanges information with each element through a system bus 83 that can have various structures.

A RAM 82 as a main memory temporally stores a computer program or data to which the processor 81 accesses immediately.

A video adaptor 85 visually outputs an operation state of the energy-related information display apparatus 80 or information to be suggested to a user through a display module 85-1.

The display module 55 can have various forms such as LCD or LED.

An input device interface 86 enables a user to input various kinds of information or instructions for operation of the energy-related information display apparatus 80 using a variety of input devices 86-1 such as key pad and touch screen.

A network interface 87 enables the energy-related information display apparatus 80 to exchange various kinds of information with the central server 15 through the communication network 13.

The local communication unit 88 enables the energy-related information display apparatus 80 to communicate with other devices such as the meter 32, the user mobile terminal 67-1, the IHD 67-2, and the energy source switch 75.

The local communication 88 can be two or more when it is needed to communicate with two or more other devices, which can be constructed to communicate with other devices located in a local area near an energy consumption place through a wired serial communication, a wireless local area communication, and a power line communication or to interface with a wide area communication network such as a mobile communication network.

A storage medium 84 stores a driving program 84-1 needed to operate the energy-related information display apparatus 80 and various kinds of data 84-2 and maintains them.

While a ROM can serve as the storage medium 84, a non-volatile property capable of read and write digital data is needed in order to frequently store or delete information to be remained and store the information regardless of whether power is supplied or not. The storage medium 84 can have various kinds and performances according to the need.

The driving program 84-1 stored in the storage medium 84 is constructed and installed to operate the energy-related information display apparatus 80 according to each embodiment of an energy-related information display method to be described below.

When the energy-related information display apparatus 80 is powered on, the processor 81 transfers the driving program 84-1 stored in the store medium 84 to the main memory 82 and executes it so that the energy-related information display apparatus 80 is operated according to each embodiment of the energy-related information display apparatus according to the present disclosure.

FIG. 8 is only an example to make the description understood, and it is of course that FIG. 8 can be variously constructed according to each embodiment of the energy-related information display apparatus of the present disclosure.

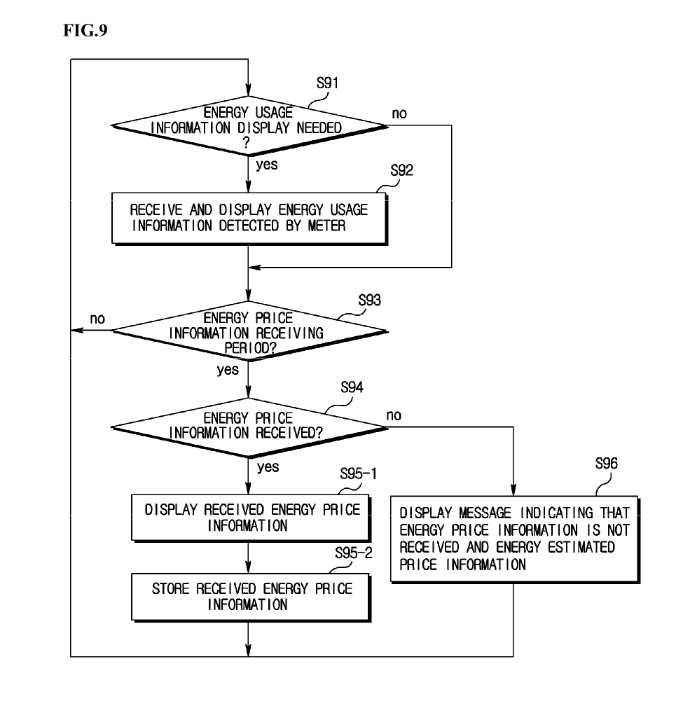

A first embodiment of the energy-related information display apparatus according to the present disclosure will be described with reference to FIG. 9.

The meter 32 detects energy and understands energy usage information. When the processor 81 needs to display energy usage information according to a driving program 84-1 (S91), it receives the energy usage information from the meter 32 through the local communication unit 88 and displays the information on a display module 85-1 through a video adaptor 85 (S92).

The state that it is needed to display the energy usage information at step S91 can be set variously, wherein the energy usage information is periodically received from the meter 32, for example.

Further, the processor 81 identify whether the energy price information is normally received from the central server 15 at the period set already (S93 and S94).

That is, since the central server 15 generally and periodically transmits the energy price information through the communication network, it is possible to identify whether the energy price information is normally received by sensing whether the energy price information is received from the central server 15 at the period.

Since steps S93 and S94 are resultantly procedures to identify whether a communication with the central server 15 is smoothly performed, any other way can also be used if it is possible to identify whether a communication is performed with the central server 15.

When the energy price information is normally received from the central server 15 as a result of identification at step S94, the processor 81 displays the energy price information received from the central server 15 on the display module 85-1 through the video adaptor 85 (S95-1).

Further, the energy price information received from the central server 15 together with additional information such as a reception day and time are stored in the storage medium 84 (S95-2).

The past energy price information stored in the storage medium 84 can be used as a basis material to predict a future energy price.

However, when the energy price information was not received from the central server 15 as a result of the identification at step S94, the processor 81 determines that the communication state is abnormal and displays a message indicating that the energy price information is not received and energy estimated price information on the display module 85-1 through the video adaptor 85 (S96).

An energy price received currently or an energy estimated price is displayed on a screen of the display module 85-1 as illustrated in FIG. 4 through steps S91 to S96 described above so that user can see them.

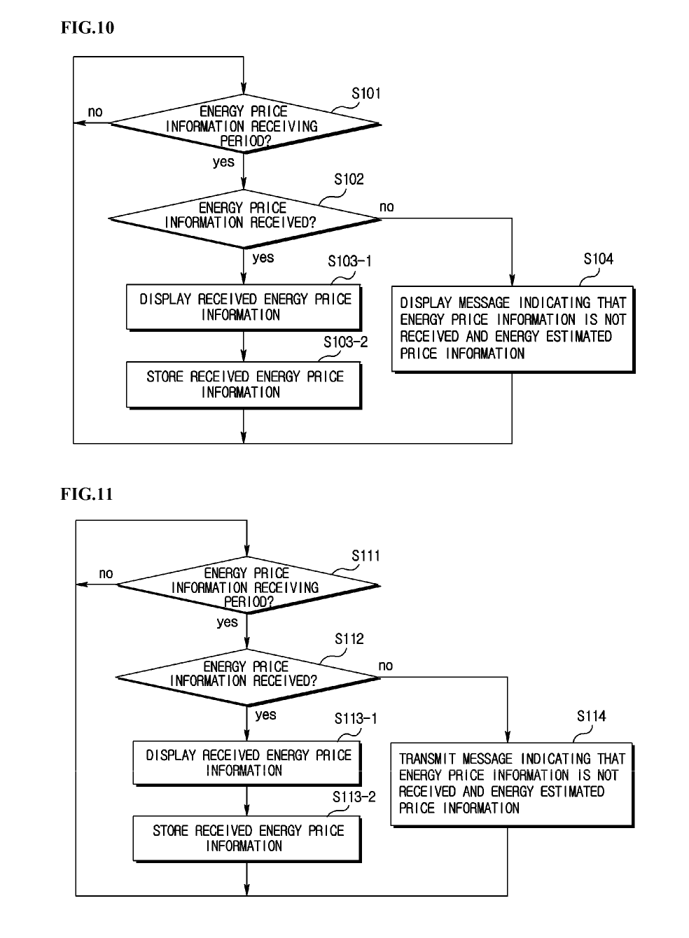

A second embodiment of an energy-related information display method according to the present disclosure will be described with reference to FIG. 10.

The processor 81 identifies whether energy price information is normally received from the central server 15 at the period set already (S101 and S102).

That is, since the central server 15 generally and periodically transmits the energy price information through the communication network 13, it is possible to identify whether the energy price information is normally received by sensing whether the energy price information is received from the central server 15 at the period.

Since S101 and S102 are resultantly procedures to identify whether a communication with the central server 15 is smoothly performed, any other way can also be used if it is possible to identify whether a communication is performed with the central server 15.

When the energy price information is normally received from the central server 15 as a result of the identification at step S102, the processor 81 displays the energy price information received from the central server 15 on the display module 85-1 through the video adaptor 85 (S103-1).

Further, the energy price information received from the central server 15 together with additional information such as receiving day and time are stored in the storage medium 84 (S103-2).

The past energy price information stored in the storage medium 84 can be used as a basic material to predict a future energy price.

However, when the energy price information was not received from the central server 15 as a result of the identification at step S102, the processor 81 determines that a communication state is abnormal and displays a message indicating that the energy price information is not received and the energy estimated price information on the display module 85-1 through the video adaptor 85 (S104).

An energy price received currently or an energy estimated price is displayed on a screen of the display module 85-1 as illustrated in FIG. 4 through steps S101 to S104 described above so that user can see them.

A third embodiment of an energy-related information display method according to the present disclosure will be described with reference to FIG. 11.

The processor 81 identifies whether energy price information is normally received from the central server 15 at the period set already (S111 and S112).

That is, since the central server 15 generally and periodically transmits the energy price information through the communication network 13, it is possible to identify whether the energy price information is normally received by sensing whether the energy price information is received from the central server 15 at the period.

Since S111 and S112 are resultantly procedures to identify whether a communication with the central server 15 is smoothly performed, any other way can also be used if it is possible to identify whether a communication is performed with the central server 15.

When the energy price information is normally received from the central server 15 as a result of the identification at step S112, the processor 81 displays the energy price information received from the central server 15 on the display module 85-1 through the video adaptor 85 (S113-1).

An energy price received currently is displayed on a screen of the display module 85-1 through step S113-1 as illustrated in FIG. 4 so that use can see it.

Further, the energy price information received from the central server 15 together with additional information such as receiving day and time are stored in the storage medium 84 (S113-2).

The past energy price information stored in the storage medium 84 can be used as a basic material to predict a future energy price.

However, when the energy price information was not received from the central server 15 as a result of the identification at step S112, the processor 81 determines that a communication state is abnormal and displays a message indicating that the energy price information is not received and energy estimated price information through a local communication unit 88 (S114).

It can be variously constructed where the message indicating that the energy price information is not received and the energy estimated price information are transmitted at step S114.

As an example, they can be transmitted to various kinds of user mobile terminal 67-1 such as mobile phone, mobile communication terminal and notebook computer.

At this time, they can be transmitted as short message or multimedia message through a communication network capable of communicating with the user mobile terminal such as wired/wireless Internet network and mobile communication network.

Information to communicate with the user mobile terminal 67-1, for example, a mobile phone number of a user, can be directly input by the user through the input device 86-1. The processor 81 stores the mobile phone number that was input directly by the user through the input device 86-1 in the storage media 84, and the number is inquired when step S114 is executed.

As another example, a message indicating that the energy price information is not received and predicted energy price information are transmitted to an IHD (In Home Display) included in house at step S114, so that the message and information are output through the IHD 67-2.

The method to produce energy estimated price in the first to third embodiments of the energy-related information display method described above can be constructed variously, and especially a current energy price can be estimated on the basis of the energy price information that was received from the central server 15 in the past.

As an example, the energy estimated price can be produced on the basis of the energy price information of the previous day or the previous month. That is, an average energy price of the previous day or the previous month, the energy price that was received at the same time zone of the previous day, and the energy price that was received at the same month, the same day and same time zone of the previous year are produced as the energy estimated price.

As another example, the latest received energy price information of the energy price information that was received before the communication state with the central server 15 became abnormal can be selected as an energy estimated price.

In the first to third embodiments of the energy-related information display method described above, when the energy price information is not received from the central server 15, the processor 81 can display an error message or a blank message instead of the energy price information. That is, an error message of ‘communication error’ or a blank message can be output to the item 41 in which the energy price is displayed in the example illustrated in FIG. 4.

The central server 15 can transmit various kinds of additional information as well as current energy price information, and the additional information may include the maximum value information and the minimum value information of the energy price.

In this case, the processor 81 can display the maximum value information and the minimum value information of the energy price that are received from the central server 15 together with the energy price information in the first to third embodiments of the energy display method.

Even though the maximum value information and the minimum value information of the energy price are not received from the central server 15, the processor 81 can select the highest price of the energy price information that was received from the central server 15 in the past as the maximum value, and the lowest price as the minimum value, and then display them.

Further, when the processor 81 does not receive the energy price information from the central server 15, it controls the energy source switch 75 through the local communication unit 88 and then switches the energy source of the energy consumption place to the substitute energy source 72 or the auxiliary battery 73 as the example described with reference to FIG. 7.

Hereinbefore, while the embodiments of the present disclosure are described, they are exemplary ones only and one of ordinary skill in the art may recognize that various alterations and modifications that fall within the scope of the present disclosure may be possible. Accordingly, the true technical protection scope of the present disclosure should be defined by the following claims.

What is claimed is:

1. An energy-related information display apparatus for receiving and displaying energy usage information and energy price information, the apparatus comprising:
a meter for detecting energy;
a usage information display unit for receiving the energy usage information from the meter and displaying the energy usage information;
a sensor for sensing a communication state between a central server and the energy-related information display apparatus;
a received information display unit for displaying energy price information when receiving the energy price information from the central server; and
an estimated information display unit for displaying a message indicating that energy price information is not received and energy estimated price information, when not receiving the energy price information from the central server.

2. The apparatus according to claim 1, wherein the received information display unit displays an error message or a blank message instead of the energy price information when not receiving the energy price information from the central server.

3. The apparatus according to claim 1, wherein the received information display unit receives at least one information of the maximum value and the minimum value in energy price from the central server and displays the received information together with the energy price information.

4. The apparatus according to claim 1, wherein the estimated information display unit determines a latest received energy price as an energy estimated price.

5. The apparatus according to claim 1, further comprising an energy source switching unit that switches an energy supply source with an alternative energy source or an auxiliary battery by controlling an energy source switch when the communication state with the central server is not normal.

6. An energy-related information display apparatus for receiving and displaying energy price information, comprising:
a sensor for sensing a communication state between a central server and the energy-related information display apparatus;
a received information display unit for displaying energy price information when receiving the energy price information from the central server; and
an estimated information display unit for displaying a message indicating that energy price information is not received and energy estimated price information, when not receiving the energy price information from the central server.

7. An energy-related information display apparatus for receiving and displaying energy price information, comprising:
a sensor for sensing a communication state between a central server and the energy-related information display apparatus;
a received information display unit for displaying energy price information when receiving the energy price information from the central server;
an estimation unit for predicting a future energy price on the basis of past energy price information received from the central server; and
a transmission unit for transmitting a message indicating that energy price information is not received and energy price information that the estimation unit has predicted, when not receiving the energy price information from the central server.

8. The apparatus according to claim 7, wherein the estimation unit predicts a future energy price on the basis of energy price information of the previous day or the previous month.

9. The apparatus according to claim 7, wherein the estimation unit predicts the latest received energy price as the future energy price.

10. The apparatus according to claim 7, wherein the transmission unit transmits a message indicating that the energy price information is not received and the energy price information that the estimation unit has predicted to a user's mobile terminal.

11. The apparatus according to claim 7, wherein the transmission unit transmits a message indicating that the energy price information is not received and the energy price information that the estimation unit has predicted to an IHD (In Home Display).

12. An energy-related information display method for receiving and displaying energy usage information and energy price information, comprising:
detecting energy with a meter;
receiving energy usage information from the meter and displaying the energy usage information;
sensing a communication state between a central server and the energy-related information display apparatus;
displaying energy price information when receiving the energy price information from the central server; and
displaying a message indicating that energy price information is not received and energy estimated price information, when not receiving the energy price information from the central server.

13. The method according to claim 12, wherein the energy is anyone of electricity, gas and water supply.

14. The method according to claim 12, wherein displaying the energy price information received from the central server includes displaying at least one information of the maximum value and the minimum value of the energy price.

15. The method according to claim 12, wherein the energy estimated price is predicted on the basis of energy price information of the previous day or the previous month.

16. The method according to claim 12, wherein the energy estimated price is the latest received energy price from the central server.

17. An energy-related information display method for receiving and displaying energy price information, comprising:
sensing a communication state between a central server and the energy-related information display apparatus;
displaying energy price information when receiving the energy price information from the central server; and
displaying a message indicating that energy price information is not received and energy estimated price information, when not receiving the energy price information from the central server.

18. An energy-related information display method for receiving and displaying energy price information, comprising:
sensing a communication state between a central server and the energy-related information display apparatus;
displaying energy price information when receiving the energy price information from the central server; and
transmitting energy estimated price information predicted on the basis of the energy price information that has been received in the past together with a message indicating the energy price information is not received, when not receiving the energy price information from the central server.

19. The method according to claim 18, wherein a message indicating that the energy price information is not received and the energy estimated price information are transmitted to a user's mobile terminal.

20. The method according to claim 18, wherein the message indicating that the energy price information is not received and the energy estimated price information are transmitted to an IHD (In Home Display).
